(19) United States
(12) Patent Application Publication
(10) Pub. No.: US 2022/0351726 A1
(43) Pub. Date: Nov. 3, 2022

(54) VIRTUAL ASSISTANT SYSTEM USING TWO-WAY RADIO

(71) Applicant: Advanced Wireless Communications, Lakeville, MN (US)

(72) Inventors: Kenneth James Coons, Lakeville, MN (US); Bernard Frederick Brondum, III, Saint Paul, MN (US)

(21) Appl. No.: 17/733,676

(22) Filed: Apr. 29, 2022

Related U.S. Application Data
(60) Provisional application No. 63/181,540, filed on Apr. 29, 2021.

(51) Int. Cl. G10L 15/22; G06F 40/205

(52) U.S. Cl. CPC G10L 15/22; G06F 40/205; G10L 2015/223; G10L 2015/221; G10L 2015/225

(57) ABSTRACT

A wireless communication system uses a two-way radio as a user interface for a virtual assistant providing a user with access to an information system. The system can receive a request spoken into the two-way radio, convert the request from speech to text, and translate the text into a task that responds to the request. In various embodiments, the task is performed to produce a response in a form depending on the nature of the request.

### CLAIM OF PRIORITY

This application claims the benefit of priority under 35 U.S.C. § 119(e) of U.S. Provisional Patent Application Ser. No. 63/181,540, filed on Apr. 29, 2021, which is herein incorporated by reference in its entirety.

### TECHNICAL FIELD

This document relates generally to virtual assistant and more particularly to a virtual assistant system that is accessible by a user using a two-way radio.

### BACKGROUND

Success of many business are increasingly dependent on effective and efficient wireless communications. Information exchanges occur frequently or constantly in organizations such as chain retail stores, senior living facilities, construction sites, and college campuses where an effective and efficient communication system needs to integrate various wired and wireless systems and devices. For example, in a chain retail store, a customer may ask an employee anywhere in the store about location and/or availability of a specific item. Unless the employee happens to remember the answers for that specific item, he or she will need to find its location in the store, whether the item has been sold out, whether the item is in stock in another store location within the chain, etc. Customer satisfaction may depend on whether the employee can provide a complete answer to the customer with minimum waiting and/or movement in the store.

### SUMMARY

A wireless communication system uses a two-way radio as a user interface for a virtual assistant providing a user with access to an information system. The system can receive a request spoken into the two-way radio, convert the request from speech to text, and translate the text into a task that responds to the request. In various embodiments, the task is performed to produce a response in a form depending on the nature of the request. For example, when the request includes a question, the task includes generating an answer to the question, and the system broadcasts the answer back to the two-way radio.

In one embodiment, a communication hub device configured to communicate with one or more two-way radios, a network, and an information system is provided. The communication device can include a radio transceiver and a processor. The radio transceiver can communicate with the one or more two-way radios. The radio transceiver includes electronics that can be configured to communicate on frequencies outside of frequencies assigned for cellular communications and can be configured to capture speech representing a request in communications received from at least one radio of the one or more two-way radios. The processor is connected to the radio receiver and can be configured to generate a response to the request using the captured speech and to send the response to the radio receiver. The radio transceiver is operable to send the response to at least one radio of the one or more two-way radios.

In one embodiment, a method for operating a virtual assistant system is provided. The method can include communicating with a two-way radio using a radio transceiver of a communication hub device. The communication can include receiving a radio signal carrying a speech representing a request for information made by speaking to the two-way radio. The two-way radio can operate in a frequency band outside of frequency ranges assigned for cellular communications. The method can further include capturing the speech using the radio transceiver, converting the captured speech into text representing the speech, parsing the text (e.g., using AI), and generating a response to the request based on the parsed text using a processor of the communication hub device.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram illustrating a communication hub device communicating with one or more two-way radios used as user interface of a virtual assistant, according to an embodiment of the present subject matter.

FIG. 2 is a block diagram illustrating a virtual assistant system using one or more two-way radios, according to an embodiment of the present subject matter.

FIG. 3 is a flow chart illustrating a method for operating a virtual assistant using one or more two-way radios, according to an embodiment of the present subject matter.

FIG. 4 is a flow chart illustrating a method for converting speech to text or intent using a network-based language processing service, according to an embodiment of the present subject matter.

FIG. 5 is a flow chart illustrating a method for generating a response to a request using an information system, according to an embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

This document discusses, among other things, a wireless communication system that provides a user with access to one or more services by speaking into a two-way radio. A modern communication system can assist an organization with managing its communications by integrating and/or coordinating various systems and devices such as a security alarm system, a telephone system, an inventory system, and an information technology system that provides for access to various services available via a network. The present subject matter provides such a communication system with a virtual assistance function allowing the user to speak a request into a two-way radio and receive a response in one or more forms depending on the nature of the request. In one embodiment, the response is delivered to the user through the two-way radio. For example, an employee of a retail store can speak into a two-way radio a request for inventory status of a specific merchandise item. The present system can capture the request as a speech, convert the speech into text (e.g., by using a web-based language processing service), translate the text into a task, create a response by carrying out the task, and broadcast the response such that the employee can receive the response via the two-way radio. In other embodiments, the response can include, for example, activation of an alarm, a telephone call and/or an e-mail to the user or a person identified using the request, an action delivering an audible message detailing the inventory status of an item specified in the request, and/or an acknowledgement that the user can receive using the two-way radio.

Two-way radios can transmit and receive radio signals by operating in a half-duplex mode (allowing for transmission or receiving in turn but not both simultaneously) or a full-duplex mode (allowing for both transmission and receiving simultaneously). In various embodiments, a two-way radio according to the present subject matter can operate in one or more very-high-frequency (VHF) bands (i.e., one or more frequency bands within the VHF range), one or more ultra-high-frequency (UHF) bands (i.e., one or more frequency bands within the UHF range), and/or one or more other suitable frequency bands to transmit and receive radio signals. In various embodiments, a two-way radio according to the present subject matter transmits and receives radio signals using frequencies that are not within the frequency ranges assigned for cellular communications in the region where the two-way radio is used. The two-way radio according to the present subject matter does not include a mobile phone.

Examples of frequency bands at which the two-way radio according to the present subject matter (e.g., the two-way radio 212 as discussed below) can operate include (but are not limited to):
150 MHz-160 MHz (within VHF range) and 450 MHz-470 MHz (within UHF range), for use in the United State of America and Canada;
The Private Mobile Radio, 446 MHz (or PMR466) Band (446.00625 MHz-446.19375 MHz), for use in various European countries including most countries of the European Union;
The 33-centimeter (or 900 MHz) Band (902 MHz-928 MHz), for use in International Telecommunication Union (ITU) Region 2 (the Americas, Greenland, and some of the eastern Pacific Islands);
The Business Band, including Low-band frequencies (27.430 MHz-49.580 MHz), VHF frequencies (151.505 MHz-158.4075 MHz) and UHF frequencies (462.575 MHz-469.550 MHz), for use in the United States of America; and
Unlicensed Bands, e.g., 902 MHz-928 MHz in the United States of America and 863 MHz to 870 MHz in Europe.

In various embodiments, the wireless communication system according to the present subject matter (e.g., including the two-way radio 212 and the communication hub device 100 or 200 as discussed below) can be configured to accommodate any one or more of these frequency bands, among others suitable frequency bands. It is understood that past and present standards can be used. It is also contemplated that future versions of these standards and new future standards may be employed without departing from the scope of the present subject matter.

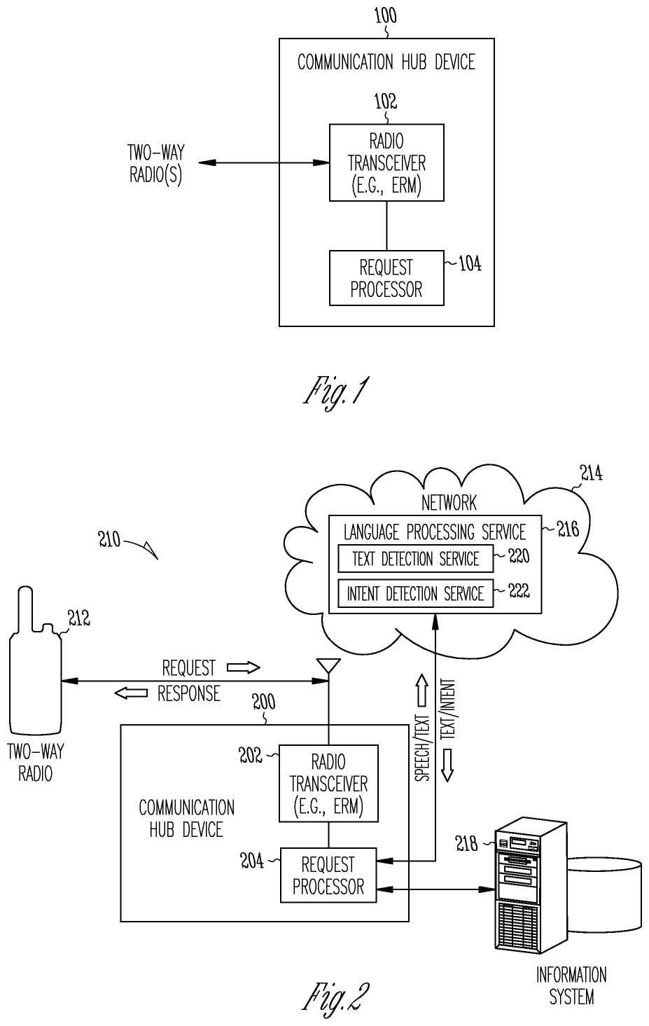

FIG. 1 is a block diagram illustrating a communication hub device 100 that communicates with one or more two-way radios used as user interface of a virtual assistant, according to an embodiment of the present subject matter. Communication hub device 100 includes a radio transceiver 102 and a request processor 104. Radio transceiver 102 can be constructed as an embedded radio module (ERM). Radio transceiver 102 can receive a radio signal from a two-way radio of the one or more two-way radios. The radio signal carries a speech representing a request made by a user speaking into the two-way radio. Radio transceiver 102 can capture the speech representing the request and can broadcast a response to the request using a radio channel when needed. Request processor 104 can convert the captured speech to text representing the speech, parse the text, and generate a task that produces the response to the request based on the parsed text.

FIG. 2 is a block diagram illustrating a virtual assistant system 210 that one or more two-way radios, according to an embodiment of the present subject matter. In the illustrated embodiment, system 210 includes a communication hub device 200 that can communicate with a two-way radio 212, a network 214, and an information system 218. While a system with one of each of the communication hub device, the two-way radio, the network, and the information system is illustrated as an example for simplicity of discussion, system 210 can include any number of each of these elements, depending on the need in each application of virtual assistance system 210. For example, system 210 can include a single communication hub device 200 that communicates with multiple two-way radios 212, network 214, and information system 218. In another example, multiple information systems 218 can be included to allow for access to different types of information and/or information from different organizations.

Communication hub device 200 can represent an example of communication hub device 100. In various embodiments, communication hub device 210 can be implemented on a modular wireless communication platform that is customizable and/or expandable by installing application-specific software and/or hardware modules. In addition to the elements illustrated in FIG. 2, communication hub device 210 can also be configured to communicate with computers, alarms, cellphones, etc.

In the illustrated embodiment, communication hub device 210 includes a radio transceiver 202 and a request processor 204. In various embodiments, communication hub device 210 can include one or more radio transceivers each serving a different purpose. In various embodiments, communication hub device 210 can include one or more additional processors each performing a different process, or a processor configured to perform multiple independent or related processes.

Radio transceiver 202 can represent an example of radio transceiver 10 and can communicate with two-way radio 212. Radio transceiver 202 can be constructed as an ERM. Radio transceiver 202 can receive a radio signal from two-way radio 212 and broadcast a response using a radio channel. The radio signal carries a speech representing a request made by the user by speaking to two-way radio 212. The response can include another radio signal carrying the response, or part of the response, to the request. The request can be in a form of a question, and the response can include the answer to the question. Radio transceiver 202 can capture the speech and send the captured speech to request processor 204. In various embodiments, the communications between radio transceiver 202 can communicate with two-way radio 212 in the UHF band, VHF band, or any frequency bands supported by two-way radio 212 (as discussed above for the two-way radio according to the present subject matter, for example, frequency bands outside of the frequencies ranges assigned for cellular communications). In one embodiment, radio transceiver 202 can identify two-way radio 212 using the radio signal received to allow for identification of the source of the request. This can be done by identifying the radio (e.g., by including information allowing for device identification in the radio signal) or the user (e.g., by recognizing the voice of a specific person). In a further embodiment, when there are multiple two-way radios 212 within the communication range, radio transceiver 202 can transmit the response only to the identified two-way radio 212 and/or the user.

Request processor 204 can represent an example of request processor 104 and can receive the captured speech and generate the response to the request represented by the speech. In one embodiment, request processor 204 can be implemented using software installed on the modular wireless communication platform.

Request processor 204 can detect information including an intent from the captured speech and generate a response. When the speech represents a request made by the user speaking to two-way radio 212, request processor 204 can determine an actionable task using the detected intent and create a response to the request using an outcome of carrying out that task. The task can include querying information system 218 for responding to the request. When the request includes a question, request processor 204 can cause a search of information system 218 for the information needed to answer the question. In various embodiments, request processor 204 can perform these functions by using its own functionalities and/or one or more resources residing in network 214, as discussed below.

In various embodiments, request processor 204 can convert the captured speech to text, parse the text to detect an intent (which can include one or more parameters) from the text, and determine the actionable task, including the form and the content of the response, based on the intent (including the one or more parameters if applicable). Request processor 204 can use available network-based services to, for example, convert the speech to text, detect the intent from the text, or detect the intent directly from the speech, and perform the remaining functions by itself.

Network (also referred to as “cloud”) 214 includes a language processing service 216 that can translate a speech into text representing the speech and/or detect an intent of the speech from the speech or the text representing the speech. In the illustrated embodiment, language processing service 216 includes a text detection service 220 and an intent detection service 222. Text detection service 220 (also referred to as a speech-to-text service) can detect text representing a speech from the speech. Intent detection service 222 can detect intent of the speech (also referred to as intent representing the speech) from the text representing the speech. In various embodiments, text detection service 220 and intent detection service 222 can be included in language processing service 216 of network 214 (as illustrated in FIG. 2), in request processor 204 of communication hub device 210, or both language processing service 216 and request processor 204, as discussed below.

In one embodiment (as illustrated in FIG. 2), language processing service 216 includes text detection service 220 and intent detection service 222 to detect the intent of the speech from the speech. Request processor 204 converts the captured speech to the text representing the speech and parses the text representing the speech to detect the intent of the speech by transmitting the captured speech to language processing service 216 in network 214 and receiving parsed text including the intent the request from the language processing service 216.

In another embodiment, language processing service 216 includes text detection service 220 to translates a speech to text representing the speech. Request processor 204 converts the captured speech to the text representing the speech by transmitting the captured speech to language processing service 216 in network 214 and receiving the text representing the speech from the language processing service 216. Examples of such a language processing service include Internet-based speech-to-text services provided by Microsoft, Google, and Amazon. Request processor 204 includes intent detection service 222 to parse the received text to detect the intent of the speech.

In yet another embodiment, request processor 204 includes text detection service 220 to convert the captured speech to the text representing the speech. request processor 204 parses the text representing the speech to detect the intent of the speech by transmitting the text representing the speech to language processing service 216 in network 214 and receiving parsed text including the intent the request from the language processing service 216. Language detection service 216 includes intent detection service 222 to parse the text representing the speech to detect the intent of the speech.

In various embodiments, request processor 204 and/or language processing 216 can include an AI-based intent engine to detect the intent including the parameter(s) from a variety of phrases that may be spoken with the same intent including parameter(s). For example, the user may speak to two-way radio 212: “may I book a ticket for flying to Cairo from Minneapolis?” “please book me a flight from Minneapolis to Cairo,” or “I need to book a flight from Minneapolis to Cairo.” The intent engine can detect from any of these phrases that the intent is to book a flight, and the parameters are “from Minneapolis” and “to Cairo”. Once the intent is detected, request processor 204 can use it to determine the actionable task. The task can include conversation between communication hub device 200 and the user via two-way radio 212 to obtain necessary additional information such as possible dates and times for flying. When the request includes a question for which the user intends to receive an answer, request processor 204 can understand the question and define a search for the answer based on the understanding of the question as part of the task. The search can include querying information system 218. Request processor 204 can then generate the response including an answer to the question based in the search result.

Information system 218 can be communicatively coupled to communication hub device 202 through a wired or wireless connection. In various embodiments, information system 218 includes a searchable storage device to store information for responding to the request. An example of information system 218 includes an inventory system allowing for search of inventory status of an item using its name, a reference code, and/or other identifiers.

Two-way radio 212 is used as a user interface for communication hub device 200 to receive the speech from the user and deliver the response (e.g., a machine-generated speech) to the user. Two-way radio 212 can transmit the radio signal carrying the speech to communication hub device 200 and receive the radio signal carrying the response from communication hub device 200.

In one example of application, virtual assistant system 210 is used to allow users each carrying a two-way radio 212 to check inventory, such as in a merchandise warehouse or retail store. For example, one of the users speaks a question into his two-way radio 212: “how many units of SKU 23456 are in stock?” radio transceiver 202 of communication hub device 200 receives and captures the user's speech including the question. Request processor 204 transmits the speech or the text representing the speech to language processing service 216 in network 214, which translates the speech or text including the question and transmits text representing the detected intent back to request processor 204. Request processor 204 searches information system 218 (e.g., an inventory system of the warehouse or retail store) to find the number of units of SKU 23456 in stock. Request processor 204 then generates the response (answer): “There are 10 units of SKU 23456 in stock.” The response is broadcasted to be received by two-way radio 212 using radio transceiver 202 and spoken to the user using two-way radio 212. In various embodiments, such a system can also provide the user with information such as specific locations of a merchandise item in the warehouse or store, number of units of the merchandise item in another warehouse or store when there is none in stock, future availability (e.g., status of back order) of the merchandise item when there is none in stock, suggestions for a substitute or alternative to the merchandise item, and any other information that may help the user with providing customer satisfaction. In various embodiments, such a system can also generate related work orders, such as allowing user to request one or more units of SKU 23456 to be moved to a shelf in the shopping area or purchase of additional units of SKU 23456 when the inventory is low.

In various embodiments, circuits of communication hub device 100 or communication hub device 200, including its various embodiments discussed herein, may be implemented using a combination of hardware and software. For example, the circuit of radio transceiver 102, request processor 104, radio transceiver 202, and request processor 204 may each be implemented using an application-specific circuit constructed to perform one or more particular functions or a general-purpose circuit programmed to perform such function(s). Such a general-purpose circuit includes, but is not limited to, a microprocessor or a portion thereof, a microcontroller or portions thereof, and a programmable logic circuit or a portion thereof.

It is understood that a communication hub device as discussed herein, including communication hub device 100 or 200 communication hub device, includes at least one processor (e.g., request processor 104 or request processor 204). The processor may be a digital signal processor (DSP), microprocessor, microcontroller, field programmable gate array, other digital logic, application specific integrated circuit (ASIC), or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory, such as register, cache memory, read-only memory (ROM), random access memory (RAM), programmable read-only memory (PROM), and erasable programmable read-only memory (EPROM). In various embodiments, the processor or other processing devices execute instructions to perform a number of signal processing tasks. In various embodiments, different realizations of the block diagrams, circuits, and processes set forth herein can be created by one of skill in the art without departing from the scope of the present subject matter.

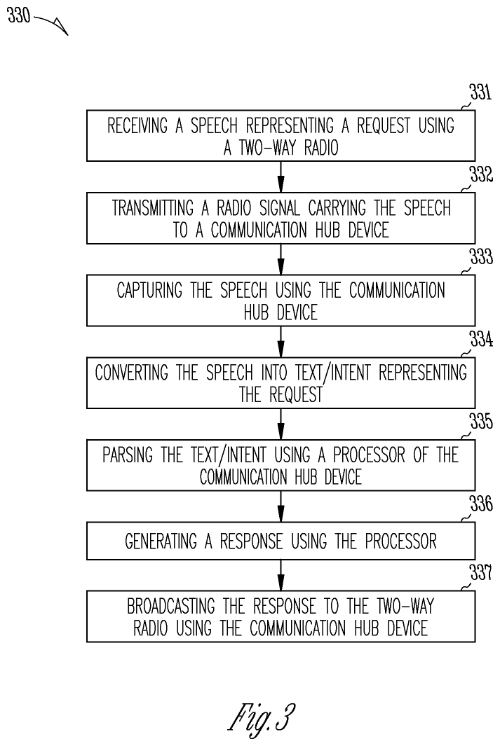

FIG. 3 is a flow chart illustrating a method 330 for operating a virtual assistant using one or more two-way radios, according to an embodiment of the present subject matter. In one embodiment, method 330 can be performed using communication hub device 100 and a two-way radio or using virtual assistant system 210.

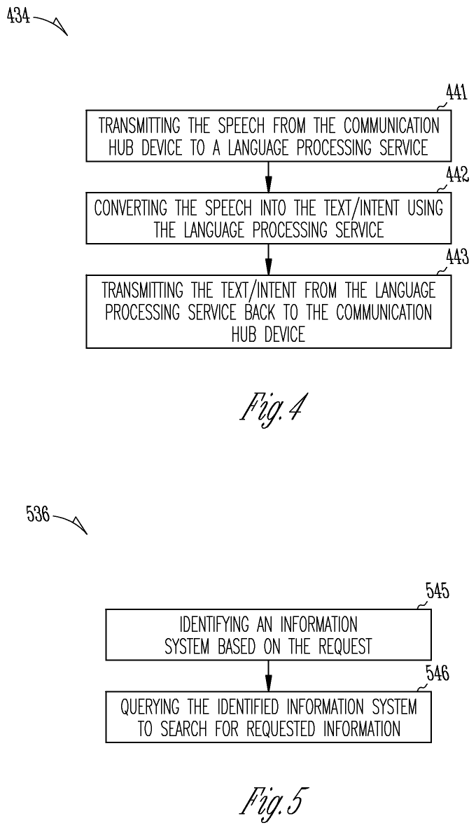

At 331, a speech is received from a user requesting information by speaking a request into a two-way radio. The speech represents the request. At 332, a radio signal carrying the speech is transmitted from the two-way radio to a communication hub device. At 333, the speech is captured using the communication hub device. In one embodiment, the communication hub device includes an ERM that receives the radio signal and captures the speech by processing the radio signal. At 334, the speech is converted into text or an intent representing the request. In various embodiments, the conversion is performed using a processor of the communication device or remotely, using a speech-to text service in a network, as further discussed below with reference to FIG. 4. At 335, the text or intent representing the speech is parsed using the processor of the communication hub device. In various embodiments, the text or intent representing the speech is parsed to understand the request by identifying and/or interpreting the intent (including one or more parameters if applicable) using the processor. At 336, a response to the request is generated based on the parsed text including the intent using the processor of the communication hub device. This can include a task defined by the identified intent and parameter(s) and performed for generating the response. Optionally at 337 (e.g., performed when the request includes a question), the response (e.g., an answer to the question) is broadcasted using a radio channel of the communication hub device to be received by the two-way radio. The two-way radio speaks the response to the user. When applicable, the broadcasted response can include an acknowledgement of the request.

FIG. 4 is a flow chart illustrating a method 434 for converting the speech to the text of intent representing the speech using a network-based language processing service, according to an embodiment of the present subject matter. In one embodiment, method 434 is performed as step 334 of method 330.

At 441, the speech is transmitted from the communication hub device to the language processing service. In one embodiment, the language processing service is an Internet-based text detection service (also referred to speech-to-text service), such as one provided by Microsoft, Google, or Amazon. In another embodiment, the language processing service is an Internet-based intent detection service (also referred to as speech-to-intent service), such as one provided by Microsoft, Google, or Amazon. At 442, the speech is converted into the text or intent representing the speech using the language processing service. At 443, the text or intent representing the speech is transmitted from the language processing service back to the communication hub device.

FIG. 5 is a flow chart illustrating a method 536 for generating the response to the request using an information system, according to an embodiment of the present subject matter. In one embodiment, method 536 is performed as step 336 of method 330.

At 545, an information system is identified based on the parsed text. At 546, the identified information system is queried based on the request, such as by searching for the requested information. For example, when the speech includes a question regarding inventory status of a merchandise item, and an inventory system is identified and queried to obtain an answer to the question.

Some non-limiting examples (Examples 1-20) of the present subject matter are provided as follows:

In Example 1, a communication hub device configured to communicate with one or more two-way radios, a network, and an information system is provided. The communication device can include a radio transceiver and a processor. The radio transceiver can communicate with the one or more two-way radios. The radio transceiver includes electronics that can be configured to communicate on frequencies outside of frequencies assigned for cellular communications and can be configured to capture speech representing a request in communications received from at least one radio of the one or more two-way radios. The processor is connected to the radio receiver and can be configured to generate a response to the request using the captured speech and to send the response to the radio receiver. The radio transceiver is operable to send the response to at least one radio of the one or more two-way radios.

In Example 2, the subject matter of Example 1 may optionally be configured such that the radio transceiver is an embedded radio module (ERM).

In Example 3, the subject matter of any one or any combination of Examples 1 and 2 may optionally be configured such that the processor is configured to detect an intent of the speech and to determine an actionable task using the intent of the speech and to create the response using an outcome of the performance of the task.

In Example 4, the subject matter of Example 3 may optionally be configured such that the processor is configured to query the information system for responding to the request.

In Example 5, the subject matter of Example 4 may optionally be configured such that the request includes a question, the response includes an answer to the question, and the processor is configured to understand the question, to define a search for the answer based on the understanding of the question, to search the information storage system, and to generate the answer to the question using a result of the search.

In Example 6, the subject matter of Example 5 may optionally be configured such that the radio transceiver is further configured to broadcast the response including the answer to the request using a radio channel.

In Example 7, the subject matter of any one or any combination of Examples 1 to 6 may optionally be configured such that the processor is configured to transmit the captured speech to the network.

In Example 8, the subject matter of Example 7 may optionally be configured such that the processor is configured to receive text representing the speech from the network and to translate the text representing the speech into the actionable task.

In Example 9, the subject matter of Example 7 may optionally be configured such that the processor is configured to receive an intent of the speech from the network and to determine the actionable task using the intent of the speech, the intent of the speech detected from the captured speech transmitted to the network.

In Example 10, the subject matter of any one or any combination of Examples 1 to 6 may optionally be configured such that the processor is configured to transmit the captured speech to the network, to receive from the network an intent of the speech detected from the captured speech, and to determine the actionable task using the intent of the speech.

In Example 11, the subject matter of any one or any combination of Examples 1 to 6 may optionally be configured such that the processor is configured to transmit the captured speech to the network, to receive from the network text representing the speech detected from the captured speech, and to determine the actionable task using the text representing the speech.

In Example 12, the subject matter of any one or any combination of Examples 1 to 11 may optionally be configured such that the radio transceiver is configured to identify the at least one radio from which the speech representing the request is received and to broadcast the response to that radio.

In Example 13, a method for operating a virtual assistant system is provided. The method can include communicating with a two-way radio using a radio transceiver of a communication hub device. The communication can include receiving a radio signal carrying a speech representing a request for information made by speaking to the two-way radio. The two-way radio can operate in a frequency band outside of frequency ranges assigned for cellular communications. The method can further include capturing the speech using the radio transceiver, converting the captured speech into text representing the speech, parsing the text (e.g., using AI), and generating a response to the request based on the parsed text using a processor of the communication hub device.

In Example 14, the subject matter of Example 13 may optionally further include broadcasting at least part of the response using a radio channel of the radio transceiver to be received by one or more two-way radios including the two-way radio from which the radio signal is received.

In Example 15, the subject matter of generating the response to the request based on the parsed text as found in any one or any combination of Examples 13 and 14 may optionally include identifying an information system based on the parsed text, querying the identified information system based on the request, and generating the response using an outcome of the query.

In Example 16, the subject matter of capturing the speech as found in Example 15 may optionally include capturing an audible message including a question regarding inventory status of an item, and the subject matter of querying the identified information system as found in Example 14 may optionally include searching for an answer from an inventory system.

In Example 17, the subject matter of parsing the text as found in Example 15 may optionally include identifying an intent including one or more parameters from the text, and the subject matter of generating the response to the request based on the parsed text as found in Example 14 may optionally include determining a task based on the identified intent including the one or more parameters.

In Example 18, the subject matter of converting the captured speech into the text representing the speech as found in any one or any combination of Examples 13 to 17 may optionally include converting the captured speech into text representing the speech using the processor of the communication hub device, and the subject matter of parsing the text as found in any one or any combination of Examples 13 to 17 may optionally include transmitting the text representing the speech to a network-based service and parsing the text to detect an intent of the speech using the network-based service.

In Example 19, the subject matter of converting the captured speech into the text representing the speech as found in any one or any combination of Examples 13 to 17 may optionally include transmitting the captured speech to a network-based service and converting the captured speech into the text representing the speech using the network-based service.

In Example 20, the subject matter of parsing the text as found in Example 19 may optionally include parsing the text to detect an intent of the speech using the network-based service.

In Example 21, the subject matter of parsing the text as found in Example 19 may optionally include receiving the text representing the speech from the network-based service using the communication hub device and parsing the text to detect an intent of the speech using the processor of the processor of the communication hub device.

It is to be understood that the above detailed description is intended to be illustrative, and not restrictive. Other embodiments will be apparent to those of skill in the art upon reading and understanding the above description. The scope of the present subject matter should be determined with reference to the appended claims, along with the full scope of legal equivalents to which such claims are entitled.

What is claimed is:

1. A communication hub device configured to communicate with one or more two-way radios, a network, and an information system, the device comprising:
a radio transceiver to communicate with the one or more two-way radios, the radio transceiver including electronics configured to communicate on frequencies outside of frequencies assigned for cellular communications and to capture speech representing a request in communications received from at least one radio of the one or more two-way radios; and
a processor connected to the radio receiver, the processor configured to generate a response to the request using the captured speech and to send the response to the radio receiver,
wherein the radio transceiver is operable to send the response to at least one radio of the one or more two-way radios.

2. The device of claim 1, wherein the radio transceiver is an embedded radio module (ERM).

3. The device of claim 1, wherein the processor is configured to detect an intent of the speech and to determine an actionable task using the intent of the speech and to create the response using an outcome of the performance of the task.

4. The device of claim 3, wherein the processor is configured to query the information system for responding to the request.

5. The device of claim 4, wherein the request includes a question, the response includes an answer to the question, and the processor is configured to understand the question, to define a search for the answer based on the understanding of the question, to search the information storage system, and to generate the answer to the question using a result of the search.

6. The device of claim 5, wherein the radio transceiver is further configured to broadcast the response including the answer to the request using a radio channel.

7. The device of claim 1, wherein the processor is configured to transmit the captured speech to the network.

8. The device of claim 7, wherein the processor is configured to receive text representing the speech from the network and to translate the text representing the speech into the actionable task.

9. The device of claim 7, wherein the processor is configured to receive an intent of the speech from the network and to determine the actionable task using the intent of the speech, the intent of the speech detected from the captured speech transmitted to the network.

10. The device of claim 1, wherein the processor is configured to transmit the captured speech to the network, to receive from the network an intent of the speech detected from the captured speech, and to determine the actionable task using the intent of the speech.

11. The device of claim 1, wherein the processor is configured to transmit the captured speech to the network, to receive from the network text representing the speech detected from the captured speech, and to determine the actionable task using the text representing the speech.

12. The device of claim 1, wherein the radio transceiver is configured to identify the at least one radio from which the speech representing the request is received and to broadcast the response to that radio.

13. A virtual assistant method, comprising:
communicating with a two-way radio using a radio transceiver of a communication hub device, including receiving a radio signal carrying a speech representing a request for information made by speaking to the two-way radio, the two-way radio operating in a frequency band outside of frequency ranges assigned for cellular communications;
capturing the speech using the radio transceiver;
converting the captured speech into text representing the speech;
parsing the text; and
generating a response to the request based on the parsed text using a processor of the communication hub device.

14. The method of claim 13, further comprising broadcasting at least part of the response using a radio channel of the radio transceiver to be received by one or more two-way radios including the two-way radio from which the radio signal is received.

15. The method of claim 14, wherein generating the response to the request based on the parsed text comprises:
identifying an information system based on the parsed text;
querying the identified information system based on the request; and
generating the response using an outcome of the query.

16. The method of claim 15, wherein capturing the speech comprises capturing an audible message including a question regarding inventory status of an item, and querying the identified information system comprises searching for an answer from an inventory system.

17. The method of claim 15, wherein parsing the text comprises identifying an intent including one or more parameters from the text, and generating the response to the request based on the parsed text comprises determining a task based on the identified intent including the one or more parameters.

18. The method of claim 13, wherein converting the captured speech into the text representing the speech comprises converting the captured speech into text representing the speech using the processor of the communication hub device, and parsing the text comprises:
transmitting the text representing the speech to a network-based service; and
parsing the text to detect an intent of the speech using the network-based service.

19. The method of claim 13, wherein converting the captured speech into the text representing the speech comprises:
transmitting the captured speech to a network-based service; and
converting the captured speech into the text representing the speech using the network-based service.

20. The method of claim 19, wherein parsing the text comprises parsing the text to detect an intent of the speech using the network-based service.

21. The method of claim 19, wherein parsing the text comprises:
receiving the text representing the speech from the network-based service using the communication hub device; and
parsing the text to detect an intent of the speech using the processor of the processor of the communication hub device.
